(19) United States
(12) Patent Application Publication
(10) Pub. No.: US 2020/0099077 A1
(43) Pub. Date: Mar. 26, 2020

(54) FUEL CELL ELECTROLYTE AND METHOD FOR MANUFACTURING SAME

(71) Applicants: DENSO CORPORATION, Kariya-city (JP); Kyoto University, Kyoto-shi (JP)

(72) Inventors: Ryota SHINOZAKI, Kariya-city (JP); Nobuyoshi SAKAKIBARA, Kariya-city (JP); Tomoya ITAKURA, Kariya-city (JP); Susumu KITAGAWA, Kyoto-city (JP); Satoshi HORIKE, Kyoto-city (JP)

(21) Appl. No.: 16/695,279

(22) Filed: Nov. 26, 2019

Related U.S. Application Data
(63) Continuation of application No. PCT/JP2018/020963, filed on May 31, 2018.

(30) Foreign Application Priority Data
Jun. 2, 2017 (JP) 2017-110033

(51) Int. Cl. H01M 8/103; H01M 8/1039; H01M 8/106; H01M 8/1048; H01M 8/1081; H01M 8/1051

(52) U.S. Cl. CPC H01M 8/103; H01M 8/1039; H01M 8/106; H01M 2008/1095; H01M 8/1081; H01M 8/1051; H01M 8/1048

(57) ABSTRACT

A fuel cell electrolyte includes: a porous member; and a proton conductive material supported by the porous member. The proton conductive material includes a metal ion, an oxoanion, and a proton coordination molecule. At least one of the oxoanion and the proton coordination molecule coordinates with the metal ion to provide a coordination polymer. A relative density is equal to or higher than 75%.

### CROSS REFERENCE TO RELATED APPLICATION

The present application is a continuation application of International Patent Application No. PCT/JP2018/020963 filed on May 31, 2018, which designated the U.S. and claims the benefit of priority from Japanese Patent Application No. 2017-110033 filed on Jun. 2, 2017. The entire disclosures of all of the above applications are incorporated herein by reference.

### TECHNICAL FIELD

The present disclosure relates to relates to a fuel cell electrolyte and a method for manufacturing the same.

### BACKGROUND

A proton conductive material can be used for a fuel cell electrolyte. This proton conductive material can be used even at high temperatures, and can be used under non-humidified or low humidified conditions.

### SUMMARY

According to an example, a fuel cell electrolyte includes: a porous member; and a proton conductive material supported by the porous member. The proton conductive material includes a metal ion, an oxoanion, and a proton coordination molecule. At least one of the oxoanion and the proton coordination molecule coordinates with the metal ion to provide a coordination polymer. A relative density is equal to or higher than 75%.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory view showing a method of attaching electrodes on both sides of a fuel cell electrolyte;

FIG. 2 is a perspective view showing the configuration of a single cell of a fuel cell;

FIG. 3 is an explanatory view showing an example of a method for manufacturing a fuel cell electrolyte;

FIG. 4A is an explanatory diagram showing polyacrylic acid (PAA), FIG. 4B is an explanatory diagram showing polyvinyl phosphonic acid (PVPA), FIG. 4C shows polystyrene sulfonic acid (PSSA), and FIG. 4D is an explanatory diagram showing deoxyribonucleic acid (DNA);

FIG. 5 is an explanatory view showing a method for manufacturing a fuel cell electrolyte; and

FIG. 6 is an explanatory diagram showing a configuration of a membrane electrode assembly.

### DETAILED DESCRIPTION

As a result of detailed studies by the present inventors, an object has been found that the fuel cell electrolyte is required to have high gas sealing property. In one aspect of the present disclosure, it is preferable to provide a fuel cell electrolyte having a high gas sealing property and a method for manufacturing the same.

One aspect of the present disclosure is a fuel cell electrolyte. A fuel cell electrolyte according to one aspect of the present disclosure includes a porous member and a proton conductive material supported by the porous member. The proton conductive material includes a metal ion, an oxoanion, and a proton coordination molecule. The oxoanion and/or the proton coordination molecule is coordinated to the metal ion to form a coordination polymer. The relative density of the fuel cell electrolyte according to one aspect of the present disclosure is 75% or more.

The fuel cell electrolyte according to one aspect of the present disclosure has a high relative density, and thus has a high gas sealing property.

Another aspect of the present disclosure is a method for manufacturing a fuel cell electrolyte. A solution including a metal ion, an oxoanion, and a proton coordination molecule is contacted with a porous member, and the solvent of the solution is removed from the porous member, so that a proton conducting material supported by the porous member is formed. The proton conductive material includes the metal ion, the oxoanion, and the proton coordination molecule. The oxoanion and/or the proton coordination molecule is coordinated to the metal ion to form a coordination polymer.

According to the method for manufacturing a fuel cell electrolyte according to another aspect of the present disclosure, a fuel cell electrolyte having a high relative density and a high gas sealing property can be manufactured.

Here, the reference numerals in parentheses indicate correspondence to the concrete means described in the embodiments, which is an example of the present disclosure. Thus, the technical scope of the present disclosure is not necessarily limited thereto.

Exemplary embodiments of the present disclosure will be described with reference to the drawings.

### 1. Fuel Cell Electrolyte

### (1-1) Porous Member

The fuel cell electrolyte includes a porous member. The porous member supports the proton conductive material. The supporting the proton conductive material means to keep the shape or position of the proton conductive material to be constant. For example, at least a part of the proton conductive material may be impregnated with the porous member. Alternatively, a proton conductive material film may be formed on the surface of the porous member.

The porous member includes, for example, a resin. The porous member may be a member made of a resin, or a member made of a resin and another material. Examples of the resin include Teflon (registered trademark), polyimide, acrylic, cellulose, polyolefin, aramid, polyamide, and polyester. Further, the porous member includes, for example, an inorganic substance. The porous member may be a member made of an inorganic material, or may be a member made of an inorganic material and another material. Examples of inorganic substances include glass wool and silica. Examples of the shape of the porous member include a membrane shape and a plate shape.

### (1-2) Proton Conductive Material

The fuel cell electrolyte includes a proton conductive material. The proton conductive material is supported by the porous member. The proton conductive material includes a metal ion, an oxoanion, and a proton coordination molecule. The oxoanion and/or proton-coordination molecule is coordinated to a metal ion to form a coordination polymer.

Examples of the oxoanion include phosphate ion and sulfate ion. From the viewpoint of chemical stability against hydrogen, a phosphate ion is preferred as the oxoanion. The form of phosphate ion may be a form of hydrogen phosphate ion in which one proton is coordinated, or may be a form of dihydrogen phosphate ion in which two protons are coordinated.

The oxoanion is coordinated to the metal ion, for example, in the form of a monomer in which condensation has not occurred. When the oxoanion is a monomer, the proton conductive material is maintained at a high proton concentration. In addition, when the oxoanion is a monomer, the proton conductive material is excellent in moisture stability.

The proton coordination molecule is a molecule having preferably two or more coordination points in the molecule for coordinating protons. As the proton coordination molecules, imidazole, triazole, benzimidazole, benztriazole, and derivatives thereof are preferable. Since these proton coordination molecules have coordination points with an excellent balance between proton coordination and release, they are excellent in ion conductivity.

Here, the derivative means one obtained by replacing a part of the chemical structure with another atom or atomic group. Specific examples of the derivatives include 2-methylimidazole, 2-ethylimidazole, histamine, histidine and the like. These are imidazole derivatives.

Examples of the proton coordination molecule include a primary amine represented by the general formula R—NH₂, a secondary amine represented by the general formula R¹ (R²) —NH, and a tertiary amine represented by the general formula R¹ (R²) (R³) —N. Here, R, R¹, R², and R³ are each independently any one of an alkyl group, an aryl group, an alicyclic hydrocarbon group, and a heterocyclic group.

Examples of the primary amine include a lower alkylamine such as methylamine, ethylamine, propylamine and the like, and an aromatic amine such as aniline and toluidine.

Examples of the secondary amine include di-lower alkyl amines such as dimethylamine, diethylamine, dipropylamine and the like, and aromatic secondary amines such as N-methylaniline, N-methyltoluidine and the like.

Examples of the tertiary amine include tri-lower alkyl amines such as trimethylamine and triethylamine. Examples of proton coordination molecules include carbon linear diamines such as ethylenediamine and N-lower alkyl derivatives of ethylenediamine. Examples of N-lower alkyl derivatives include tetramethylethylenediamine and the like.

Examples of proton coordination molecules include saturated cyclic amines such as pyrrolidine, N-lower alkyl pyrrolidine, piperidine, N-lower alkyl piperidine, morpholine, N-lower alkyl morpholine. Examples of N-lower alkylpyrrolidines include N-methylpyrrolidine. Examples of the N-lower alkyl piperidine include N-methyl piperidine.

Examples of the proton coordination molecule include saturated cyclic diamines such as piperazine, N-lower dialkylpiperazine, and 1,4-diazabicyclo [2.2.2] octane. Examples of N-lower dialkylpiperazines include N, N-dimethylpiperazine. 1,4-diazabicyclo [2.2.2] octane is also called triethylenediamine.

The metal ion is not particularly limited. As the metal ion, a high periodic transition metal ion or a typical metal ion is preferable. As metal ions, cobalt ions, copper ions, zinc ions, and gallium ions are particularly preferable. Cobalt ions, copper ions, zinc ions, and gallium ions tend to form a coordinate bond with the oxoanion and/or proton coordination molecule.

In the proton conductive material, it is desirable that the mixing ratio of the oxoanion is 1 to 4 mol and the proton coordination molecule is 1 to 3 mol with respect to 1 mol of the metal ion. In this mixing ratio, the coordination polymer can be efficiently formed.

When the mixing ratio of oxoinion or proton coordination molecule is less than 1 mol with respect to 1 mol of metal ion, a coordination polymer may not be formed. In addition, when more than 4 moles of oxoanions are mixed with respect to 1 mole of metal ions, or when more than 3 moles of proton coordination molecules are mixed, the proton conductive material does not become solid and it shows very high hygroscopic property, so that the shape stability may be significantly reduced.

The proton conductive material may include an additive material in addition to the metal ion, the oxoanion, and the proton coordination molecule. Examples of the additive material include one or more selected from the group consisting of oxoacids, metal oxides, organic polymers, and alkali metal ions. When the proton conductive material includes any of these additive materials, the proton conductive material has a higher ionic conductivity at a low temperature without reducing the high temperature performance of the proton conductive material. The high temperature is, for example, 100° C. or higher. The low temperature is, for example, less than 100° C.

The addition amount of the additive material is preferably in the range of 1 to 20 parts by mass, where the total mass of the metal ion, oxoanion, and proton coordination molecule is 100 parts by mass.

Examples of the oxo acid include phosphoric acid, nitric acid, sulfuric acid, and similar compounds thereof. When the total mass of the metal ion, the oxoanion and the proton coordination molecule is 100 parts by mass, the addition amount of oxo acid is preferably in the range of 2 to 150 parts by mass. When the addition amount of oxo acid is 2 parts by mass or more, the above-described effects due to the additive material becomes more remarkable. When the addition amount of the oxo acid is 150 parts by mass or less, the coordination polymer can be prevented from being decomposed due to the acidity of the oxo acid.

When the additive material is a metal oxide or an organic polymer, the addition amount of the additive material is preferably in the range of 5 to 20 parts by mass. When the addition amount of the additive material is within this range, the ionic conductivity at a low temperature of the proton conductive material is further increased without impairing the performance of the proton conductive material at a high temperature.

Examples of the metal oxide include one or more selected from the group consisting of SiO₂, TiO₂, Al₂O₃, WO₃, MoO₃, ZrO₂, and V₂O₅. When any one of these metal oxides is used, the ionic conductivity of the proton conductive material at a low temperature is further increased without impairing the performance of the proton conductive material at a high temperature.

The particle size of the metal oxide is preferably in the range of 5 to 500 nm. When the particle diameter of the metal oxide is within this range, the ionic conductivity of the proton conductive material at a low temperature is further increased without impairing the performance of the proton conductive material at a high temperature. The particle size is a value obtained by taking a photograph of particles of a metal oxide with an electron microscope (e.g., SEM) and image-analyzing the obtained image.

The organic polymer preferably has an acidic functional group. When an organic polymer having an acidic functional group is used, the ionic conductivity of the proton conductive material at a low temperature is further increased without impairing the performance of the proton conductive material at a high temperature. Examples of the acidic functional group include a carboxyl group (—COOH), a sulfonic acid group (—SO₃H), and a phosphonic acid group (—PO₃H₂). The organic polymer has pH preferably in the range of 4 or less. When the pH is 4 or less, the ionic conductivity of the proton conductive material at a low temperature is further increased without impairing the performance of the proton conductive material at a high temperature.

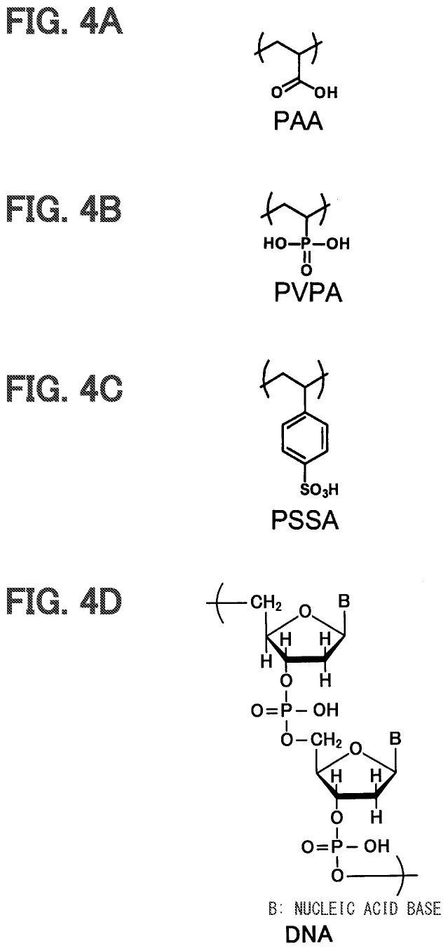

Examples of the organic polymer include polyacrylic acid (PAA) shown in FIG. 4A, polyvinylphosphonic acid (PVPA) shown in FIG. 4B, polystyrene sulfonic acid (PSSA) shown in FIG. 4C, and deoxyribonucleic acid (DNA) shown in FIG. 4D.

Examples of the alkali metal ion include one or more metal ions selected from the group consisting of Li, Na, K, Rb, and Cs. When these alkali metal ions are used, the ionic conductivity of the proton conductive material becomes higher at low and high temperatures.

When the additive is included, the proton conductive material can be obtained by further adding an additive to a solution including, for example, a metal ion, an oxoanion, and a proton coordination molecule.

### (1-3) Relative Density

The relative density of the fuel cell electrolyte of the present disclosure is 75% or more. When the relative density is 75% or more, the gas sealing property of the fuel cell electrolyte is high. The relative density is more preferably 80% or more, and particularly preferably 90% or more. When the relative density is 80% or more, the gas sealability of the fuel cell electrolyte is even higher. When the relative density is 90% or more, the gas sealing property of the fuel cell electrolyte is particularly high. The method for measuring the relative density is the method described in the example embodiments described later.

### (1-4) Applications of Fuel Cell Electrolytes

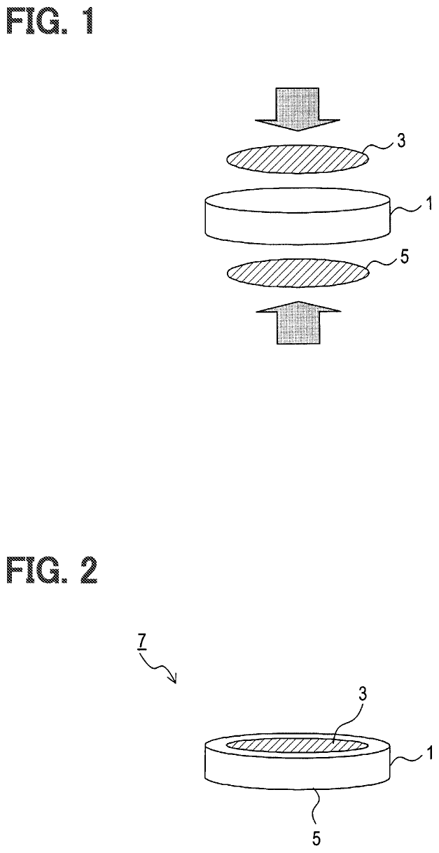

The fuel cell electrolyte may be a constituent element of the fuel cell. For example, as shown in FIG. 1, the electrodes 3 and 5 are attached to both sides of the fuel cell electrolyte 1 to manufacture the single cell 7 of the fuel cell shown in FIG. 2.

### 2. Manufacturing Method of Fuel Cell Electrolyte

In the method for manufacturing a fuel cell electrolyte, a solution including a metal ion, an oxoanion, and a proton coordination molecule is contacted with a porous member, and the solvent of the solution is removed from the porous member. A proton conductive material is formed by the metal ions, oxoanions, and proton coordination molecules in the solution. The formed proton conductive material is supported by the porous member. The proton conductive material has the configuration described in the section “(1-2) Proton conductive material”.

Examples of the solvent for the solution include water and ethanol. Examples of the method for preparing the solution include a method in which a metal ion, an oxoanion, and a proton coordination molecule are mixed with a solvent.

Examples of the features in which the solution contacts the porous member include, for example, a feature in which the solution is dropped onto the porous member, a feature in which the porous member is immersed in the solution, a feature in which the solution is applied to the porous member, and a feature in which the solution is sprayed onto the porous member.

Examples of the feature for removing the solvent of the solution from the porous member include a feature for natural drying, a feature for heating, a feature for blowing air, a feature for reducing pressure, and the like.

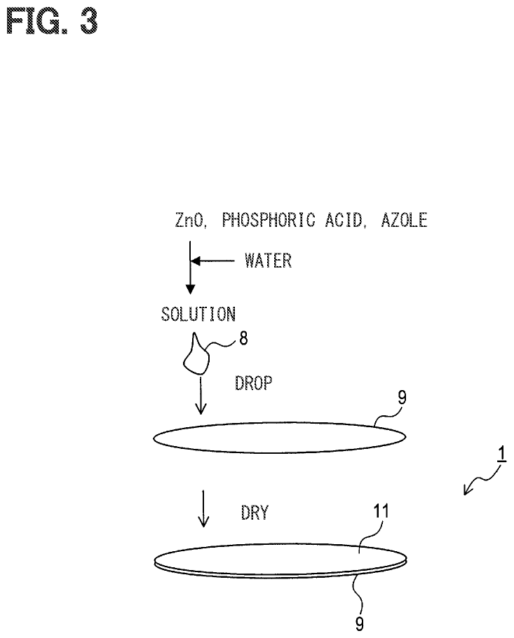

An example of a method for manufacturing a fuel cell electrolyte is shown in FIG. 3. First, water is added to ZnO, phosphoric acid, and azole to prepare a solution. ZnO is a metal ion source. Zn ions are present in the prepared solution. Phosphoric acid corresponds to the oxoanion. An azole corresponds to a proton coordination molecule.

Next, the prepared solution 8 is dropped onto the porous member 9. Next, the solvent of the solution 8 is removed by drying to complete the fuel cell electrolyte 1. In the fuel cell electrolyte 1, the proton conductive material 11 is supported by the porous member 9.

The relative density of the manufactured fuel cell electrolyte is preferably 75% or more. In this case, the gas sealing property of the manufactured fuel cell electrolyte is further enhanced.

### 3. Embodiments

### (3-1) First Embodiment

ZnO, 1,2,4-triazole, phosphoric acid, and water are mixed in the amounts shown in the column “Embodiment 1” in Table 1 to prepare a raw material solution S1.

TABLE 1

| | | Embodiment No. | | | |
|---|---|---|---|---|---|
| | | Emb 1 | Emb 2 | Emb 3 | Comparison |
| Raw material | ZnO (g) | 0.81 | 1.50 | 1.50 | 1.50 |
| component | 1,2,4-triazole | 1.79 | 2.55 | 2.55 | 2.55 |
| | phosphoric acid (85%) (mL) | 2.80 | 2.52 | 3.27 | 3.27 |
| | Water (mL) | 122.2 | 5.0 | 5.0 | 5.0 |
| | Relative density (%) | 95 | 92 | 95 | 70 |
| | Open circuit voltage (V) | 0.95 | 0.91 | 0.94 | 0.71 |
| | Hydrogen concnetration (ppm) | 0.2 | 10 | 5 | 1000 |
| | Conductivity (mS/cm) | 15 | 0.1 | 6.0 | 4.0 |

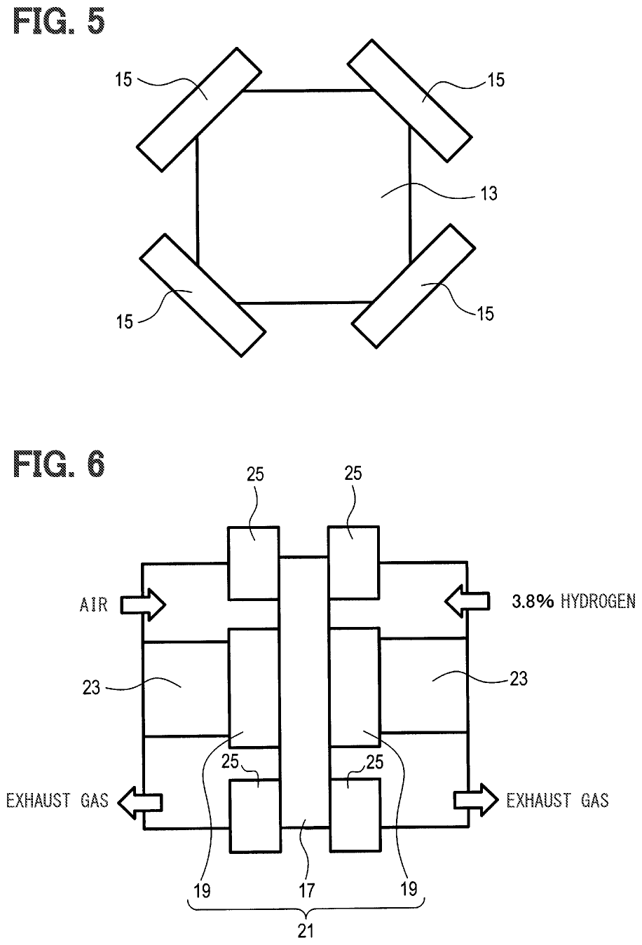

As shown in FIG. 5, the membrane filter 13 is cut into 15 mm squares, placed on a Teflon plate (not shown), and the four corners are fixed with tape 15. This membrane filter 13 is a hydrophilized Teflon membrane filter made by Merck Millipore. The membrane filter 13 corresponds to a porous member made of resin.

Next, 113 μL of the raw material solution S1 is dropped on the membrane filter 13 and dried at 80° C. for 3 hours. The above dropping step and drying step are repeated three times to manufacture a fuel cell electrolyte. In this fuel cell electrolyte, the membrane filter 13 supports a proton conductive material. The relative density d (%) of the fuel cell electrolyte is calculated using the following Equation (1).

$$\begin{matrix}d = \frac{{W}_{m} - {W}_{n}}{{V}_{cp} \cdot {d}_{mat}} \times 100 & [ Equation 1 ] \\ {V}_{cp} = {V}_{m} - {V}_{n} & [ Equation 2 ] \\ {V}_{m} = L \times {A}_{m} & [ Equation 3 ] \\ {V}_{n} = A \times {L}_{n} \times \frac{100 - P}{100} & [ Equation 4 ]\end{matrix}$$

Wm in Equation (1) is the mass of the fuel cell electrolyte. Wn is the mass of the untreated membrane filter 13. The unit of Wm and Wn is gram. VCP in Equation (1) is the sum of the volume of pores in the untreated membrane filter 13 and the volume of the proton conductive material. The unit of VCP is milliliter. VCP is calculated by Equation (2). In the Equation (2), Vm is the volume of the fuel cell electrolyte. The unit of Vm is milliliter. Vm is calculated by Equation (3). L in Equation (3) is the thickness of the fuel cell electrolyte. The unit of L is centimeter. Am in Equation (3) is the area of the fuel cell electrolyte. The unit of Am is square centimeter.

Vn in Equation (2) is the volume of the resin in the untreated membrane filter 13. The unit of Vn is milliliter. Vn is calculated by Equation (4). A in Equation (4) is the area of the untreated membrane filter 13. The unit of A is square centimeter. Ln in Equation (4) is the thickness of the untreated membrane filter 13. The unit of Ln is centimeter. P in Equation (4) is the porosity (%) in the untreated membrane filter 13. dₘₐₜ in the Equation (1) is the material density of the proton conductive material obtained from the crystal structure. The unit of dₘₐₜ is g/mL.

As shown in FIG. 6, the electrode 19 is attached to both surfaces of the fuel cell electrolyte 17 manufactured above, and the membrane electrode assembly 21 is manufactured. The electrode 19 is a commercially available platinum-supported carbon electrode for a fuel cell, and is punched to have a diameter of 7 mm. Further, the current collector 23 and the gasket 25 are attached to the membrane electrode assembly 21.

While supplying 3.8% of hydrogen to the electrode 19 on one side of the membrane electrode assembly 21 at a flow rate of 60 mL/min and supplying dry air to the electrode 19 on the other side at a flow rate of 60 mL/min, the membrane electrode assembly 21 is heated to 120° C. In this state, the voltage between both electrodes 19 is measured. This voltage is an open circuit voltage. The measurement results of the open circuit voltage are shown in Table 1 above.

Further, the exhaust gas on the electrode 19 side to which the air is supplied is analyzed by gas chromatography, and the hydrogen concentration is measured. The higher the hydrogen concentration, the more hydrogen gas leaks through the fuel cell electrolyte 17. The measurement results of the hydrogen concentration are shown in Table 1 above.

Further, the conductivity of the fuel cell electrolyte 17 is measured using both the electrodes 19. The conductivity measurement results are shown in Table 1 above.

### (3-2) Second Embodiment

ZnO, 1,2,4-triazole, phosphoric acid, and water are mixed in the amounts shown in the column of “Embodiment 2” in Table 1, and the mixture is dried at 80° C. to obtain proton conductive material powder. 0.1 gram of the obtained proton conductive material powder is dissolved in 100 ml of water to prepare a raw material solution S2.

As shown in FIG. 5, the membrane filter 13 is cut into 15 mm squares, placed on a Teflon plate (not shown), and the four corners are fixed with tape 15. The membrane filter 13 is the same as that in the first embodiment.

Next, 600 μL of the raw material solution S2 is dropped on the membrane filter 13 and dried at 80° C. for 3 hours. The above dropping step and drying step are repeated three times to manufacture a fuel cell electrolyte. In this fuel cell electrolyte, the membrane filter 13 supports a proton conductive material.

Using the obtained fuel cell electrolyte, the relative density d, the open circuit voltage, the hydrogen concentration, and the conductivity are measured in the same manner as in Embodiment 1. The measurement results are shown in Table 1 above.

### (3-3) Third Embodiment

ZnO, 1,2,4-triazole, phosphoric acid, and water are mixed in the amounts shown in the column of “Embodiment 3” in Table 1, and the mixture is dried at 80° C. to obtain proton conductive material powder. 0.1 gram of the obtained proton conductive material powder is dissolved in 100 ml of water to prepare a raw material solution S3.

As shown in FIG. 5, the membrane filter 13 is cut into 15 mm squares, placed on a Teflon plate (not shown), and the four corners are fixed with tape 15. The membrane filter 13 is the same as that in the first embodiment.

Next, 600 μL of the raw material solution S3 is dropped on the membrane filter 13 and dried at 80° C. for 3 hours. The above dropping step and drying step are repeated three times to manufacture a fuel cell electrolyte. In this fuel cell electrolyte, the membrane filter 13 supports a proton conductive material.

Using the obtained fuel cell electrolyte, the relative density d, the open circuit voltage, the hydrogen concentration, and the conductivity are measured in the same manner as in Embodiment 1. The measurement results are shown in Table 1 above.

### (3-4) Comparison

ZnO, 1,2,4-triazole, phosphoric acid, and water are mixed in the amounts shown in the column of “Comparison” in Table 1, and the mixture is dried at 80° C. to obtain proton conductive material powder.

1 gram of the obtained proton conductive material powder is suspended in 20 mL of ethanol. This suspension is placed in a 50 mL polyethylene pot. 10 gram of zirconia balls having 5 mm diameter are added to a polyethylene pot, and ball milling step is performed at a speed of 100 rpm. The zirconia balls are taken out from the liquid, and a raw material solution R is obtained.

As shown in FIG. 5, the membrane filter 13 is cut into 15 mm squares, placed on a Teflon plate (not shown), and the four corners are fixed with tape 15. The membrane filter 13 is the same as that in the first embodiment.

Next, 120 μL of the raw material solution R is dropped on the membrane filter 13 and dried at 80° C. for 3 hours. The above dropping step and drying step are repeated three times to manufacture a fuel cell electrolyte.

Using the obtained fuel cell electrolyte, the relative density d, the open circuit voltage, the hydrogen concentration, and the conductivity are measured in the same manner as in Embodiment 1. The measurement results are shown in Table 1 above.

### 4. Other Embodiments

While the embodiment of the present disclosure has been described, the present disclosure is not limited to the embodiment described above and can be modified in various manners.

(1) A plurality of functions of one element in the above embodiments may be implemented by a plurality of elements, or one function of one element may be implemented by a plurality of elements. Further, multiple functions of multiple elements may be implemented by one element, or one function implemented by multiple elements may be implemented by one element. A part of the configuration of the above embodiments may be omitted. At least a part of the configuration of the above embodiments may be added to or replaced with another configuration of the above embodiments. All features included in the technical idea identified by the wording correspond to embodiments of the present disclosure.

(2) In addition to the fuel cell electrolyte described above, the present disclosure can be realized in various forms such as a fuel cell using the fuel cell electrolyte as a constituent element, a method for manufacturing the fuel cell, and the like.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A fuel cell electrolyte comprising:
a porous member; and
a proton conductive material supported by the porous member, wherein:
the proton conductive material includes a metal ion, an oxoanion, and a proton coordination molecule;
at least one of the oxoanion and the proton coordination molecule coordinates with the metal ion to provide a coordination polymer; and
a relative density is equal to or higher than 75%.

2. The fuel cell electrolyte according to claim 1, wherein:
the porous member includes a resin or an inorganic substance.

3. The fuel cell electrolyte according to claim 1, wherein:
the porous member includes at least one of Teflon, polyimide, acrylic, and cellulose.

4. The fuel cell electrolyte according to claim 1, wherein:
the oxoanion is a monomer.

5. The fuel cell electrolyte according to claim 1, wherein:
the oxoanion is one or more selected from the group consisting of a phosphate ion, a hydrogen phosphate ion, and a dihydrogen phosphate ion.

6. The fuel cell electrolyte according to claim 1, wherein:
the proton coordination molecule is one or more selected from the group consisting of imidazole, triazole, benzimidazole, benztriazole, and derivatives thereof.

7. The fuel cell electrolyte according to claim 1, wherein:
the proton coordination molecule is one or more selected from the group consisting of a primary amine represented by a general formula of R—NH₂, a secondary amine represented by a general formula of R¹ (R²) —NH, a tertiary amine represented by a general formula of R¹ (R²) (R³) —N, a linear carbon diamine, a saturated cyclic amine, and a saturated cyclic diamine; and
R, R¹, R², and R³ each independently represent any one of an alkyl group, an aryl group, an alicyclic hydrocarbon group, and a heterocyclic group, respectively.

8. The fuel cell electrolyte according to claim 1, wherein:
the metal ion is one or more selected from the group consisting of a cobalt ion, a copper ion, a zinc ion, and a gallium ion.

9. A method for manufacturing a fuel cell electrolyte comprising:
contacting a porous member with a solution including a metal ion, an oxoanion, and a proton coordination molecule;
removing a solvent of the solution from the porous member; and
forming a proton conductive material supported by the porous member;
the proton conductive material includes the metal ion, the oxoanion, and the proton coordination molecule; and
at least one of the oxoanion and the proton coordination molecule coordinates to the metal ion to form a coordination polymer.

10. The method for manufacturing the fuel cell electrolyte according to claim 9, wherein:
the porous member includes a resin or an inorganic substance.

11. The method for manufacturing the fuel cell electrolyte according to claim 9, wherein:
the porous member includes at least one of Teflon, polyimide, acrylic, and cellulose.

12. The method for manufacturing the fuel cell electrolyte according to claim 9, wherein:
the oxoanion is a monomer.

13. The method for manufacturing the fuel cell electrolyte according to claim 9, wherein:
the oxoanion is one or more selected from the group consisting of a phosphate ion, a hydrogen phosphate ion, and a dihydrogen phosphate ion.

14. The method for manufacturing the fuel cell electrolyte according to claim 9, wherein:
the proton coordination molecule is one or more selected from the group consisting of imidazole, triazole, benzimidazole, benztriazole, and derivatives thereof.

15. The method for manufacturing the fuel cell electrolyte according to claim 9, wherein:
the proton coordination molecule is one or more selected from the group consisting of a primary amine represented by a general formula of R—NH₂, a secondary amine represented by a general formula of R¹ (R²) —NH, a tertiary amine represented by a general formula of R¹ (R²) (R³) —N, a linear carbon diamine, a saturated cyclic amine, and a saturated cyclic diamine; and
R, R¹, R², and R³ each independently represent any one of an alkyl group, an aryl group, an alicyclic hydrocarbon group, and a heterocyclic group, respectively.

16. The method for manufacturing the fuel cell electrolyte according to claim 9, wherein:
the metal ion is one or more selected from the group consisting of a cobalt ion, a copper ion, a zinc ion, and a gallium ion.
